(19) United States
(12) Patent Application Publication
(10) Pub. No.: US 2011/0267962 A1
(43) Pub. Date: Nov. 3, 2011

(54) METHOD AND SYSTEM FOR PREDICTIVE DESIGNATED ROUTER HANDOVER IN A MULTICAST NETWORK

(75) Inventors: Suganya J S A, Bangalore (IN); Rangaprasad Sampath, Bangalore (IN)

(73) Assignee: HP Development Company LP, Houston, TX (US)

(21) Appl. No.: 12/821,079

(22) Filed: Jun. 22, 2010

(30) Foreign Application Priority Data
Apr. 29, 2010 (IN) 1030/DEL/2010

(51) Int. Cl. H04L 12/26; H04W 40/00

(52) U.S. Cl. 370/242; 370/312

(57) ABSTRACT

A method for predictive designated router (DR) handover in a multicast network is described herein. The network includes one or more sources, one or more receivers, a rendezvous point (RP) network device, a DR network device, and a plurality of DR-capable network devices. A prediction of failover of the DR network device is determined, prior to an occurrence of failover. In response to the prediction, a protocol independent multicast (PIM) Hello packet that relinquishes the DR role is transmitted. A determination is made as to whether a DR-capable network device is present in the multicast network.

### I. BACKGROUND

Multicasting is a method for simultaneously delivering data over a network from one or more data sources to a number of data receivers in a multicast group. Multicasting systems employ routing protocols to link the data sources to the appropriate data receivers in an efficient manner.

Multicasting networks are provided by multicast enabled nodes within or connected to an existing network. The nodes comprise multicast sources, multicast receivers and multicast routers. A multicast source is a source of the multicast data that is carried via the network to multicast receivers. The multicast routers are arranged to route the multicast data packets across the network between the multicast sources and receivers.

Two tasks are performed for the implementation of a multicast network. Firstly, the membership of a set of receivers is managed. A multicasting group management protocol may be implemented on network nodes that connect receivers, to enable the management of the joining receivers to a multicast group. An example of a group management protocol is the Internet Group Management Protocol (IGMP).

Secondly, the routing of the multicast data over the network is managed. A multicasting routing protocol may be implemented on each node in the network to enable the automatic creation of multicast distribution trees, such as a tree information base (TIB), between the multicast sources and receivers. Examples of such routing protocols include Protocol Independent Multicast (PIM) protocols. The IGMP and PIM protocols are implemented generally in accordance with standards defined by the Internet Engineering Task Force (IETF).

In the PIM sparse mode (PIM-SM) standard as described in RFC 4601, a multicast router may serve a special function as a rendezvous point (RP) or a designated router (DR). In any network, a single DR is designated to forward multicast traffic from the directly connected hosts, such as by sending all multicast packets from the sources of an interface to the RP.

Failover of a DR may have a significant impact on network performance. The time for failover detection, a subsequent election of a new DR, and registration of the new DR with the RP may result in multicast traffic loss that may not be easily tolerated.

### II. BRIEF DESCRIPTION OF THE DRAWINGS

The present disclosure may be better understood and its numerous features and advantages made apparent to those skilled in the art by referencing the accompanying drawings.

FIG. 1 is a topological block diagram of a network system in accordance with an embodiment of the invention.

FIG. 2 is a process flow diagram for predictive designated router handover in accordance with an embodiment of the invention.

FIG. 3 is a simplified diagram of relinquishment of a designated router role in accordance with an embodiment of the invention.

FIG. 4 is a block diagram of an exemplary switching or routing device in accordance with an embodiment of the invention.

### III. DETAILED DESCRIPTION OF THE INVENTION

In a network configured according to the PIM-SM standard, multiple PIM-SM routers may be capable of acting as a designated router (DR) for an interface, i.e., local area network (LAN), point-to-point link, or similar. A single one of the PIM-SM routers is selected to act as the presiding DR to act on behalf of multicast sources connected to the interface. The presiding DR may suffer an outage which would render it unable to perform its duties. The outage may be due to hardware, software, or other common failover condition which places the DR out of service. PIM-SM routers for an interface periodically exchange PIM Hello messages (with non-zero hold time) among the other PIM-SM routers on that interface.

Typically, the failover of the presiding DR is detected through non-receipt of the Hello messages. The default PIM Hello time interval is 30 seconds with a hold time of 105 seconds. Where a neighboring PIM-SM router has not received a Hello packet from the presiding DR within the hold time, it may be determined that a failover has occurred. As such, the time to detect DR failure is about 105 seconds with a default configuration.

When the failover is detected, a DR election is performed whereby a new presiding DR is elected among the PIM-SM routers for the interface. The newly elected DR registers itself with a rendezvous point (RP) as the presiding DR for the interface. It is not until after detection, election, and registration, that traffic from the sources are forwarded through the new DR to the RP, and through the RR to the DR. As such, multicast traffic is lost starting from the point of failure of the presiding DR and until the newly elected DR is registered with the RP.

Some solutions incur excessive wasted bandwidth by replicating source traffic between a presiding DR and a secondary or backup DR. However such solutions do not address the lengthy failover detection time and are reactive in nature.

A device and method for predictive DR handover is described herein. A process for handing over DR duties may be triggered before an actual DR failure is encountered. Traffic loss due to DR failover is significantly reduced without a significant increase in bandwidth consumption. Moreover, the time to recover from the DR unavailability for a network is significantly reduced.

A method for predictive designated router (DR) handover in a multicast network is described herein. The network includes one or more sources, one or more receivers, a rendezvous point (RP) network device, a DR network device, and a plurality of DR-capable network devices. A prediction of failover of the DR network device is determined, prior to an occurrence of failover. In response to the prediction, a protocol independent multicast (PIM) Hello packet that relinquishes the DR role is transmitted. A determination is made as to whether a DR-capable network device is present in the multicast network.

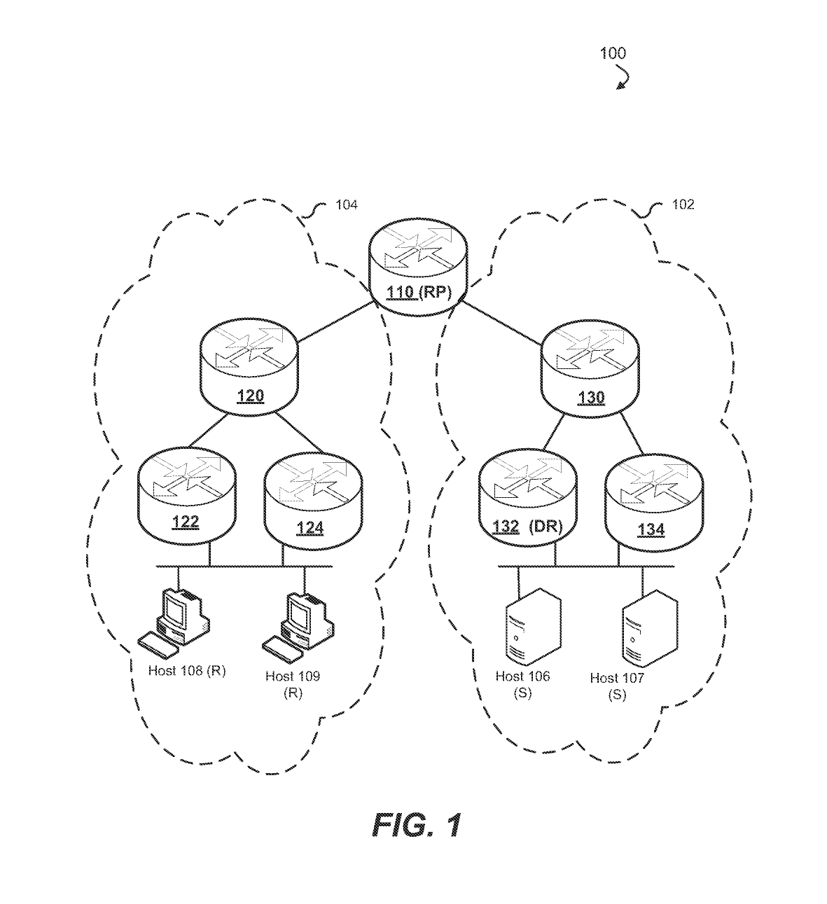

FIG. 1 is topological block diagram of a network system in accordance with an embodiment of the invention. Network 100 includes a local network 102 and a remote network 104. Local network 102 is a sub-network such as a local area network (LAN). Remote network 104 is also a sub-network such as a LAN. Multicasting is commonly used to distribute data over IP networks, such as IP network 100.

Local network 102 includes a host 106, a host 107, and a plurality of PIM-SM routers, such as router 130, router 132, and router 134. Host 106 and host 107 are multicast sources. Router 132 and router 134 may be capable of acting as a designated router (DR) for an interface (e.g., local network 102). As used herein, a DR-capable router is a PIM-SM router that is capable of acting as a DR.

Host 106, host 107, router 132, and router 134 are operatively interconnected and the connection among them may include multiple network segments, transmission technologies and components.

A single one of the DR-capable routers is selected to act as the presiding DR to act on behalf of hosts connected to the interface. Router 132 is generally configured to process and transfer data in remote network 102. Router 132 is an edge device on the edge of a network, such as remote network 102. As used herein, an edge device is a network switch, router, or other network device on the edge of a network, such as local network 102. Host devices connect directly to the edge device via an edge port. As used herein, an edge port is a port of an edge device. Additionally, router 132 is a presiding DR and is configured to create multicast distribution trees, receive the traffic of sources connected to the local network 102, such as host 106 and host 107, encapsulate the traffic, and/or deliver multicast traffic to receivers which are members of a multicast group.

Router 134 is configured to process and transfer data in remote network 102. Router 134 is an edge device on the edge of a network, such as remote network 102, and is a DR-capable router.

Router 130 is operatively coupled to router 110, router 132, and router 134 and is configured to process and transfer data in a network, such as local network 102. Additionally, router 130 is a receiver for traffic of a designated multicast group.

Router 110 is operatively coupled to router 120 and router 130. Router is an RP and is configured to be the root of a non-source-specific distribution tree for a multicast group. Furthermore, router 110 is configured to receive traffic from sources, such as host 106 and host 107, via a DR, such as router 132. Router 110 may be an edge device.

Remote network 104 includes a host 108, a host 109, and a plurality of PIM-SM routers, such as router 120, router 122, and router 124. Host 108 and host 109 are multicast receivers. Router 122 and router 124 may be DR-capable routers for an interface (e.g., remote network 104).

Router 120 is operatively coupled to router 110, router 122, and router 124 and is configured to process and transfer data in a network, such as local network 104. Additionally, router 120 is a receiver for traffic of a designated multicast group.

Router 122 is generally configured to process and transfer data in remote network 104. Router 122 is an edge device on the edge of a network, such as remote network 104. Additionally, router 122 is a presiding DR and is configured to create multicast distribution trees, receive the traffic of sources connected to the local network 104, such as host 108 and host 109, encapsulate the traffic, and/or deliver multicast traffic to receivers which are members of a multicast group.

Router 124 is configured to process and transfer data in remote network 104. Router 124 is an edge device on the edge of a network, such as remote network 104, and is a DR-capable router.

Host 108, host 109, router 122, and router 124 are operatively interconnected and the connection among them may include multiple network segments, transmission technologies and components. Together, the source hosts 106-107 and receiver hosts 108-109 comprise a multicast group.

Host 107 may be activated to send data traffic to a preconfigured multicast group IP address via router 132, which is the DR for local network 102. In one embodiment, a multicast distribution tree may be implemented to include a source tree of a multicast flow from host 107 to receiver hosts 108-109, denoted (S, G) where S is the IP address of the source and G is the multicast group address. In this embodiment, the root of the multicast distribution tree is router 132.

In another embodiment, a multicast distribution tree is implemented to include shared trees of a multicast flow, denoted (*, G) where * is a wildcard notation representing all sources and G is the multicast group address. In this embodiment, router 110 may be used as a rendezvous point (RP), such that the multicast data from host 107 is multicast from host 107 to the presiding DR (i.e., router 132) which is then unicast to the RP (i.e., router 110) and multicast, via the established shared routing tree, to each of receiver hosts 108-109. The root of the multicast distribution tree is a single common root placed at a chosen network device in the network. The shared root, or RP may include router 110.

When a multicast packet is received by one or more of edge routers 122-124, the layer 3 packet headers are examined to determine the source and/or multicast group identification. Where the multicast distribution tree at the receiving router includes an entry for the multicast group, the multicast packet is forwarded by the router to the member hosts of the multicast group according to the multicast distribution tree.

A single multicast group is described herein, however, a number of additional groups may be set up over the same IP network 100. Each such additional group may use one or more of edge routers 110-134, any one of which may be designated as the RP for other multicast groups.

The DR for an interface services all sources for the interface. Downtime experienced by the DR may severely affect the performance of the network since all source traffic is routed through the DR.

In operation, router 132 may predict the probability of failure in its own system. For example, an event which indicates that router 132 may be or become unable to perform its duties as the presiding DR may be detected by router 132. The detection of such events may trigger router 132 to generate and transmit a packet which relinquishes the DR role and may initiate a process to elect another DR-capable router in the interface (e.g., local network 102) to take over the duties of the presiding DR. As such, recovery time of DR availability may be significantly reduced. As used herein, the recovery time is the duration of time from the failure of the current DR to the time at which a new DR becomes available in the network.

The present invention can also be applied in other network topologies and environments. Network 100 may be any type of network familiar to those skilled in the art that can support data communications using any of a variety of commercially-available protocols, including without limitation TCP/IP, SNA, IPX, AppleTalk, and the like. Merely by way of example, network 100 can be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth protocol known in the art, and/or any other wireless protocol); and/or any combination of these and/or other networks.

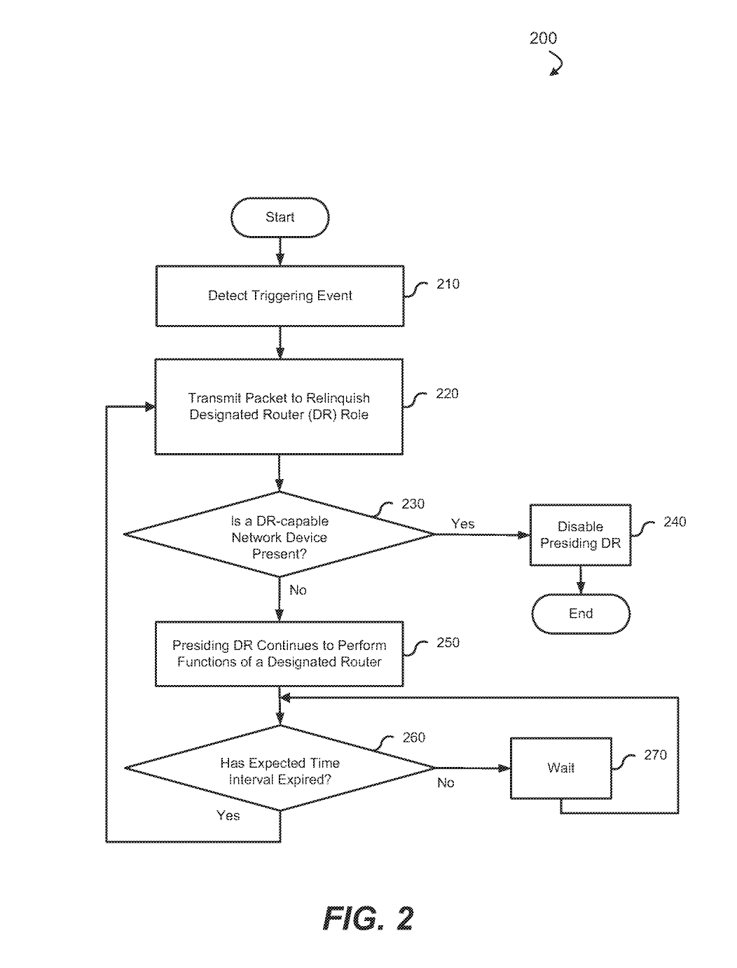

FIG. 2 is a process flow diagram 200 for predictive designated router handover in accordance with an embodiment of the invention. The depicted process flow 200 is carried out by execution of one or more sequences of executable instructions. In another embodiment, the process flow 200 is carried out by execution of components of a network device, an arrangement of hardware logic, e.g., an Application-Specific Integrated Circuit (ASIC), etc.

Predictive handover of multicast designated router (DR) responsibility may be initiated, for example by a predictive handover engine of a multicast router acting as the presiding DR in a network. At step 210, an event triggering the initiation of DR handover is detected. As used herein, the triggering event may be a condition of the presiding DR that indicates the presiding DR is likely to become unable to function in the expected manner (e.g., perform the duties of a designated router, degrading performance, etc.). In other words, the detection of the triggering event is a prediction of failover by the presiding DR prior to an actual occurrence of failure on the presiding DR.

For example, an event that triggers the predictive handover may include the detection of worsening system health. System health may refer to the capability of a router to function as expected. As used herein, a system health index (SHI) is a metric that indicates the health of the router averaged over periodic intervals of time. Various parameters may impact a SHI, such as, CPU utilization, packet backlog, route table stability, availability of system resources, security risks, etc.

In one embodiment, if a system health of the DR worsens over time, it may impact the multicasting capability of the network. To mitigate such a situation, a comparison may be made between a SHI of the DR and a high health threshold. If the SHI exceeds the high health threshold, a prediction of failover is made and handover of DR responsibility is triggered. In another embodiment, SHI is used as a factor in predicting failover.

Additionally, the triggering event may include the detection of a flapping uplink connected to an RP. Specifically, a direct connection uplink of a DR connecting to the RP is detected to be unstable. Such instability may lead to intermittent connectivity with the RP.

At step 220, a packet relinquishing the designated router (DR) role is transmitted, for example, from the DR. In one embodiment, the packet is a PIM Hello packet with a hold time set to ‘0.’ The packet may be sent before the expiration of a Hello Timer: Typically, the packet is multicast to an ‘ALL-PIM-ROUTERS’ group address per RFC 4601.

When a Hello packet from the presiding DR is received by a DR-capable router with hold time set to ‘0,’ a DR election may be commenced. PIM Hello packets are used to establish a PIM neighbor relationship. For specifying a hold time in the Hello packet, the option type field is set to 1, the length field is set to 2, and the value field is set to ‘0.’ It should be recognized that in legacy PIM-SM implementations, a DR transmits a Hello packet with the hold time set to ‘0’ when PIM is disabled on the DR. When other DR-capable routers receive the packet, a DR election is commenced and the DR-capable routers remove information about the router from which the Hello packet originated (e.g., PIM routers remove the neighbor information).

In one embodiment, the network may include one or more legacy PIM-SM routers that are not enabled to provide predictive handover. During an election, a legacy PIM-SM router may become a DR based on the priority associated with that legacy PIM-SM router. For example, a legacy PIM-SM router may be the DR where the DR_Priority Option field in the Hello packet indicates the legacy PIM-SM router is the highest priority PIM-SM router for the interface.

On the other hand, a PIM-SM router that is enabled to provide predictive handover may consider its health in addition to its priority during an election. The health of the PIM-SM routers may be determined, for example, by comparing a system health index (SHI) to a low health threshold. A DR may satisfy a minimum level of system health (enforced via the low health threshold) to qualify for participation in a DR election. As such, in one embodiment, a minimum SHI may be a prerequisite for candidate routers. PIM-SM routers whose system health is not above the low health threshold may be deemed as not DR-capable. Such a router should set the hold time to zero while sending out Hello packets. In addition to system health, the DR election may be performed based on a priority of one DR-capable router over another on the interface.

As previously described, PIM-SM routers for an interface periodically exchange PIM Hello messages among the other PIM-SM routers on that interface. At step 230, it is determined whether a DR-capable network device is present in the network. For example, it may be determined whether a Hello packet with a non-zero hold time has been received by the presiding DR from one or more of the DR-capable routers. In one embodiment, the receipt of a Hello message with non-zero hold time may indicate that there is a DR-capable router with the requisite system health present in the network and capable of becoming the new DR.

Where it is determined that a DR-capable router is present in the network, the presiding DR may be disabled, at step 240. A shutdown and/or recovery may be performed such that the presiding DR no longer performs the functions of a designated router. Specifically, once the presiding DR receives a Hello packet with a non-zero hold time from another DR-capable PIM router on the network, it initiates a recovery or shutdown process. As a part of the shutdown process, the presiding DR may send a prune message to the RP to stop the flow of multicast traffic from the RP to the DR. Additionally, the presiding DR stops forwarding multicast traffic from the hosts to the RP. Furthermore, PIM-SM may be disabled on the presiding DR and/or the presiding DR may be powered down for maintenance.

There may be a period of overlap where the presiding DR and any new DR both receive traffic for the interface. The overlap period may be brief (i.e., 1-2 seconds), thereby minimizing wasted bandwidth consumption since the source traffic is replicated for the overlap period. Once the presiding DR is disabled, the period of overlap ceases and the new DR exclusively services the sources connected to the interface. In one embodiment, since handover occurs preemptively, packet loss during recovery is reduced.

Where Hello packets are not received, the presiding DR may continue to perform the functions of the designated router for the interface at step 250. For example, where Hello packets are not received within an expected time interval, it may be the case that there are no other PIM-SM routers for the interface or that none of the PIM-SM routers on the interface are sufficiently healthy to overtake the DR responsibilities. In one embodiment the DR responsibility remains with the presiding DR until an actual point of failure at the presiding DR.

Hello packets are typically received from other PIM-SM routers at a time interval (i.e., Hello interval). At step 260, it is determined whether an expected time interval has expired. In one embodiment, the expected time interval is the Hello interval.

Where the expected time interval has not expired, the presiding DR waits at step 270 until the time interval is determined to be expired at step 260. If the expected time interval has expired, processing may continue to step 220 where another packet relinquishing the DR role is transmitted. A Hello packet with hold time set to ‘0’ may be transmitted periodically according to the time specified by a Hello timer, until, for example, the presiding DR receives Hello packets with a non-zero hold time from a DR-capable PIM router on the network and initiates a shut down or recovery process.

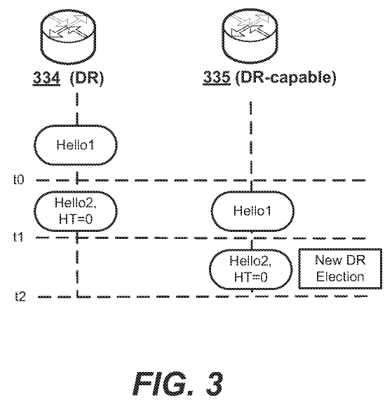

FIG. 3 is a simplified diagram of relinquishment of a designated router role in accordance with an embodiment of the invention. When failover of a designated router (DR) is predicted, before the occurrence of an actual failure, the amount of time to handover DR responsibilities is minimized. Specifically, the time to detect a failure is reduced as other available PIM-SM routers on the network are informed about a failure event by the current DR.

As previously described, PIM-SM routers for an interface periodically exchange PIM Hello messages among the other PIM-SM routers on that interface. For example, router 334 may be a presiding DR and router 335 may be a router capable of performing DR duties. Router 334 sends a Hello1 packet as a multicast at t0. Router 334 may continue to send Hello packets at regular time intervals until failover is predicted by router 334.

When router 334 predicts that a failover is likely to occur in its own systems, at time t1 router 334 transmits Hello2 packet with a hold time of ‘0.’ When the Hello2 packet is received by router 335 at t2, a new DR election may commence.

The default PIM Hello time interval is 30 seconds with a hold time of 105 seconds. The Hello time interval is used to dictate the frequency with which Hello messages are sent on each active interface. The hold time indicates the amount of time in seconds that the neighbor state is kept alive if another Hello packet from the same source is not received within that period of time.

Where the default PIM Hello interval is 30 seconds, the hold time is approximately 105 seconds. Therefore, predicting the failure before it occurs saves about 105 seconds to handover DR responsibilities. As such, router 334 is proactive (i.e., acting before a true failover is encountered) rather than reactive (i.e., acting after a failover occurs).

In one embodiment, no proprietary extensions to the RFC 4601 PIM-SM standard is proposed. As such, multi-vendor interoperability is likely.

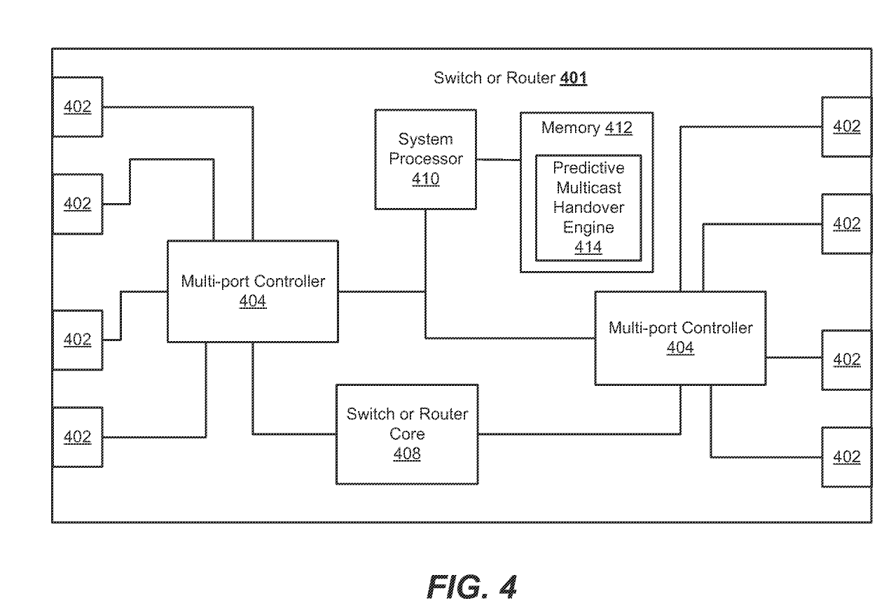

FIG. 4 is a block diagram of an exemplary switching or routing device in accordance with an embodiment of the invention. Switching or routing device 401 may be configured with multiple ports 402. The ports 402 may be controlled by one or more controller ASICs (application specific integrated circuits) 404.

The device 401 may transfer (i.e. “switch” or “route”) packets between ports by way of a conventional switch or router core 408 which interconnects the ports. A system processor 410 and memory 412 may be used to control device 401. For example, a predictive handover engine 414 may be implemented as code in memory 412 which is being executed by the system processor 410 of device 401.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage medium that are suitable for storing a program or programs that, when executed, for example by a processor, implement embodiments of the present invention. Accordingly, embodiments provide a program comprising code for implementing a system or method as claimed in any preceding claim and a machine readable storage medium storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. A method for predictive designated router (DR) handover in a multicast network, the network including one or more sources, one or more receivers, a rendezvous point (RP) network device, and a DR network device, the method comprising:
predicting, by the DR network device, failover of the DR network device prior to an occurrence of failover;
in response to predicting, transmitting a protocol independent multicast (PIM) Hello packet that relinquishes a DR role of the DR network device; and
determining whether a DR-capable network device is present in the multicast network.

2. The method of claim 1, further comprising:
disabling the DR network device upon determining that the DR-capable network device is present in the multicast network.

3. The method of claim 1, wherein predicting failover comprises detecting a triggering event in the DR network device.

4. The method of claim 3, wherein the triggering event is detection of a system health of the DR network device exceeding a high health threshold.

5. The method of claim 3, wherein the triggering event is detection of a flapping uplink connected to the RP network device.

6. The method of claim 1, further comprising:
electing a new DR, wherein the DR election is based on a system health of the new DR and a priority associated with the new DR.

7. The method of claim 1, further comprising:
electing a new DR, wherein the DR election is based on a comparison of a system health of the new DR and a low health threshold.

8. The method of claim 1, wherein determining whether a DR-capable network device is present comprises receiving, from the DR-capable network device, a PIM Hello packet having a non-zero hold time.

9. The method of claim 8, wherein the PIM Hello packet from the DR-capable network device is received within an expected time interval.

10. A system for predictive designated router (DR) handover in a multicast network, the network including one or more sources, one or more receivers, a rendezvous point (RP) network device, and a DR network device, the system comprising:
a processor; and
a memory coupled to the processor, the memory configured to store an electronic document;
wherein the processor is configured to:
predict failover of the DR network device prior to an occurrence of failover;
in response to the prediction, transmit a protocol independent multicast (PIM) Hello packet that relinquishes a DR role of the DR network device; and
determine whether a DR-capable network device is present in the multicast network.

11. The system of claim 10, wherein the processor is configured to disable the DR network device upon determining that the DR-capable network device is present in the multicast network.

12. The system of claim 10, wherein the processor is configured to predict failover by detecting a triggering event in the DR network device.

13. The system of claim 10, wherein the processor is configured to determine whether a DR-capable network device is present by receiving a PIM Hello packet having a non-zero hold time from the DR-capable network device.

14. The system of claim 13, wherein the PIM Hello packet from the DR-capable network device is received within an expected time interval.

15. A computer-readable medium storing a plurality of instructions for controlling a data processor for predictive designated router (DR) handover in a multicast network, the network including one or more sources, one or more receivers, a rendezvous point (RP) network device, and a DR network device, the plurality of instructions comprising:
instructions that cause the data processor to predict failover of the DR network device prior to an occurrence of failover;
instructions that cause the data processor to transmitting a protocol independent multicast (PIM) Hello packet that relinquishes a DR role of the DR network device, in response to predicting; and
instructions that cause the data processor to determine whether a DR-capable network device is present in the multicast network.

16. The computer-readable medium of claim 15 wherein the plurality of instructions further comprise instructions that cause the data processor to disable the DR network device upon determining that the DR-capable network device is present in the multicast network.

17. The computer-readable medium of claim 15, wherein the instructions that cause the data processor to predict failover comprises instructions that cause the data processor to detect a triggering event in the DR network device.

18. The computer-readable medium of claim 17, wherein the triggering event is detection of a system health of the DR network device exceeding a high health threshold.

19. The computer-readable medium of claim 15, wherein the instructions that cause the data processor to determine whether a DR-capable network device is present comprises instructions that cause the data processor to receive a PIM Hello packet having a non-zero hold time from the DR-capable network device.

20. The computer-readable medium of claim 19, wherein the PIM Hello packet from the DR-capable network device is received within an expected time interval.
